(19) United States
(12) Patent Application Publication
(10) Pub. No.: US 2017/0002171 A1
(43) Pub. Date: Jan. 5, 2017

(54) ADDITIVES FOR USE IN PLASTIC, RESIN AND ELASTOMER COMPOSITIONS

(71) Applicant: T&L Sugars Limited, London (GB)

(72) Inventors: John KERR, London (GB); Anthony BAIADA, London (GB)

(21) Appl. No.: 15/104,075

(22) PCT Filed: Dec. 12, 2014
(86) PCT No.: PCT/GB2014/053683

§ 371 Date: Jun. 13, 2016

(30) Foreign Application Priority Data
Dec. 13, 2013 (GB) 1322122.1

(51) Int. Cl. C08K 3/26; C08K 11/00

(52) U.S. Cl. CPC C08K 3/26; C08K 11/005; C08K 2003/265

(57) ABSTRACT

Additives for inclusion in a plastic, resin or elastomer composition, having a combination of precipitated calcium and/or magnesium salt and organic material, wherein the salt is a calcium and/or magnesium carbonate, a calcium and/or magnesium phosphate or a combination thereof, together with methods for manufacturing and using the additive.

### FIELD

The invention relates to additives for use in plastics, resins or elastomers. In particular, it relates to additives from novel sustainable sources.

### BACKGROUND

Plastics, resins and elastomers have traditionally been made from monomers or other starting materials derived from oil-based materials. More recently, increasing attention and effort is being made to derive these materials from sustainable sources, such as polyethylene made from ethene, which may be derived from ethanol (for example, fermented from sugar).

Precipitated carbonates and/or phosphates are by-products of many processes, such as carbonatation and phosphatation steps used in refining processes. In many cases, the carbonate or phosphate compound that separates out is, by the very nature of their function in the sugar processing, “contaminated” with materials removed by the refining step and frequently the materials include organic matter, as well as inorganic salts.

### SUMMARY

According to a first aspect of the invention, an additive is provided for inclusion in a plastic, resin or elastomer composition, the additive comprising a combination of precipitated calcium and/or magnesium salt and co-precipitated organic material, wherein the salt is a calcium and/or magnesium carbonate, a calcium and/or magnesium phosphate or a combination thereof.

In some embodiments, the additive comprises an intimate mixture of precipitated salt and organic material.

In some embodiments, the additive comprises organic material, and optionally inorganic material, bound to precipitated salt.

In some embodiments, the additive further comprises an inorganic material in addition to the salt.

In some embodiments, the combination of precipitated salt and organic material is a by-product of a refining process. For example, in some embodiments, the additive comprises a combination of a precipitated carbonate and organic material which is a by-product of a carbonatation step. In other embodiments, the additive comprises a combination of a precipitated phosphate and organic material which is a by-product of a phosphatation step.

In some embodiments, the combination of precipitated salt and organic material is a by-product of a sugar refining process.

In some embodiments, the combination of precipitated salt and organic material is a by-product of decolourisation processes.

In some embodiments, the additive has a particle size of up to about 50 μm, or up to about 10 μm.

In some embodiments, the additive comprises at least 10% organic material.

In some embodiments, the organic material comprises carbon, charred material or carbonised material.

According to a second aspect of the invention, a method of manufacturing an additive according to the first aspect of the invention is provided, the method comprising processing a combination of calcium and/or magnesium salt and organic material.

In some embodiments, the processing comprises a heat treatment step. In some embodiments, the heat treatment step results in the formation of carbon, charred material or carbonised material from the organic material.

In some embodiments, the combination of salt and organic material is heated to a temperature from about 200° C. to about 1000° C. for a period of about 30 minutes to about 5 hours.

In some embodiments, the method comprises adjusting the particle size of the combination of salt and organic material.

In some embodiments, the method comprises a washing step.

According to a third aspect of the invention, there is provided an additive material produced or producible by a method according to the second aspect of the invention.

In some embodiments, the material is an additive for inclusion in a plastic, resin elastomer composition.

According to a fourth aspect of the invention, use of an additive material according to the first or third aspect of the invention is provided, to provide a plastic, resin or elastomer composition.

In some embodiments, the additive material provides the plastic, resin or elastomer composition with improved properties.

In some embodiments, the use provides a plastic, resin or elastomer composition with a homogenous mixture of filler and colorant.

According to a fifth aspect of the invention, a process for preparing a plastic, resin or elastomer composition is provided, wherein the process comprises mixing a plastic, resin or elastomer starting material with an additive according to the first or third aspect of the invention.

In some embodiments, the process does not require the addition of further colorant or pigment to the plastic, resin or elastomer composition.

According to a sixth aspect of the invention, there is provided a plastic, resin or elastomer composition comprising an additive according to the first or third aspect of the invention.

### BRIEF DESCRIPTION OF DRAWINGS

For the purposes of example only, embodiments of the invention are described below with reference to the accompanying drawings, in which:

FIG. 1 is a graph showing the particle size distribution of calcium carbonate cake as may be used in connection with the present invention.

FIGS. 2 to 7 are flow charts showing steps for processing a calcium salt combination to prepare an additive according to embodiments of the present invention.

### DETAILED DESCRIPTION

According to the invention, an additive is provided for inclusion in a plastic, resin or elastomer composition, the additive comprising a combination of precipitated calcium and/or magnesium salt and organic material, wherein the salt is a calcium and/or magnesium carbonate, a calcium and/or magnesium phosphate or a combination thereof.

The invention relates to additives which may, for example, act as fillers, processing aids and/or colorants for use in plastic, resin and elastomer compositions and, in particular, to sustainable additives.

Plastics are materials that are stable but, at some point during their manufacture, were plastic, allowing them to be formed or moulded by heat, pressure or both. Most plastics are polymers, often of high molecular mass, and derived from organic monomers. Traditionally, many plastics are synthetic polymers, commonly derived from petrochemicals. However, the manufacture of plastics from sustainable sources is becoming increasingly important, with “bio” sources of monomers like ethene, which may be derived from ethanol (for example, fermented from sugar) attracting interest.

As used in the present invention, plastics include thermoplastic materials. Specific examples of materials that may be used in conjunction with the additives of the present invention include, but are not limited to, polypropylene (PP), polyethylene (PE), including for example high density polyethylene (HDPE) and low density polyethylene (LDPE), polystyrene, polyvinyl chloride (PVC), fluoropolymers such as polytetrafluoroethylene (PTFE or Teflon®), poly(methyl methacrylate) (PMMA), polyamides such as nylon, etc., and combinations thereof, such as PP and LDPE or PP and HDPE.

The term “resin” applies to nearly any liquid that will set into a hard lacquer or enamel-like finish. Resins as referred to herein are synthetic organic compounds and are liquid monomers of thermosetting plastics. Examples of resins include, for example: polyester resin, vinyl ester resin, epoxy resin, phenolic resin, furan resin and urethane resin.

Elastomers, as used herein include rubbers and they may be natural or synthetic. An elastomer is a polymer with viscoelasticity, generally having low Young's modulus and high failure strain compared with other materials. At ambient temperatures rubbers tend to be relatively soft (E˜3 MPa) and deformable. Their primary uses are for seals, adhesives and moulded flexible parts.

Examples of unsaturated elastomers that can be cured by sulphur vulcanisation include, for example, natural rubber (NR), synthetic polyisoprene (IR), butyl rubber (copolymer of isobutylene and isoprene, IIR) including halogenated butyl rubbers, polybutadiene (BR), styrene-butadiene rubber (SBR), nitrile rubber (NBR) including hydrogenated nitrile rubbers (HNBR), chloroprene rubber (CR) such as polychloroprene, etc. Examples of saturated rubbers that cannot be cured by sulphur vulcanisation include: ethylene propylene rubber (EPM) and ethylene propylene diene rubber (EPDM), epichlorohydrin rubber (ECO), polyacrylic rubber, silicone rubber, fluorosilicone rubber, fluoroelastomers, perfluoroelastomers, polyether block amides (PEBA), chlorosulfonated polyethylene (CSM), ethylene-vinyl acetate (EVA), etc. Other types of elastomers include: thermoplastic elastomers (TPE), thermoplastic vulcanizates (TPV), thermoplastic polyurethane (TPU), thermoplastic olefins (TPO), the proteins resilin and elastin, and polysulfide rubber.

Regardless of the type and/or source of the organic component of a plastic, resin or elastomer, it tends to be relatively expensive and so in many cases inorganic “fillers” are added to the compositions formed to reduce the overall cost of manufacture. Many plastic, resin and elastomer compositions contain fillers which are relatively inert and inexpensive materials that make the product cheaper by weight. Alternatively or in addition, inorganic fillers may be used to adjust or enhance specific properties of the plastic, resin or elastomer, for example to increase its specific gravity, improve its fire retardancy, improve its stiffness or strength (such as impact strength) and/or ductility, or to improve sound-proofing or sound-deadening properties, to improve the appearance of the plastic or resin, or to optimise the weight to volume ratio of the final plastic product in view of its desired purpose and performance, etc.

Several inorganic fillers may be used in the plastics and bio-resins industries including, but not limited to, calcium carbonate, talc, magnesite, sand, etc. Typically fillers are mineral in origin, e.g., chalk, and are sourced from the ground. Some fillers are more chemically active and are referred to as reinforcing agents.

Fillers may, for example, be included in plastics, resins and elastomers in an amount from about >0 to about 90%. In addition to fillers, many plastics, resins and elastomers contain other organic or inorganic compounds which are blended with the other components as additives. The amount of additives (in addition to the filler) included in plastics, resins or elastomers can range from 0% to more than about 50%.

Since many organic polymers are too rigid for particular applications, they frequently include plasticizers (the largest group of additives), which can improve rheological properties of plastics. Thus, plasticizers are a class of commonly used additives in plastics, resins and elastomers.

Colorants are also common additives, although their weight contribution is small. In many cases, “carbon black” is added to the mixture to give the finished article a black colouration. The colour black may be desirable in its own right for many products derived from “virgin” plastic materials, and it is also the colour of choice for products made from recycled plastics which may be made from a variety of different coloured plastics and the carbon black is used to eliminate any potential colour differences that may arise from products derived from recycled plastics. Although the carbon black may be added at relatively low levels on a weight % basis (typically 0.1 to 1% by weight), it is very important that carbon black is intimately and homogeneously mixed into the blend (prior to extrusion for example) and also that this homogeneity is maintained throughout the product's formation and life.

The mixing of “organic” and “inorganic” components to make a structural component often presents technical challenges to be overcome. It is critical that: (a) the inorganic and organic materials are intimately mixed to form a homogenous mixture when the plastic is processed, for example by extrusion or mould pressing; and (b) the inorganic and organic materials must be compatible, that is, the plastic needs to “wet” the inorganic material and bind to it so that the overall material has and retains structural integrity.

Typically, (a) is achieved by very efficient mixing (for example, using a Z-blade mixer) and (b) is achieved by the addition of compatibilisers.

Thus, the composition of the plastic, resin or elastomer, the inorganic filler, the compatibiliser and the mixing regime are all key to the material properties of the final product and its overall commercial viability.

To summarise, for commercial plastics, resins and elastomers there are required:
i) sustainable and less expensive sources of components, including additives, and in particular fillers that are sustainably sourced;
ii) intimate mixing of a complex range of components;
iii) compatibility of the inorganic components and the organic (including colorant, such as carbon black) components; and/or
iv) homogeneity of the components within the finished product.

Calcium carbonate (for example, in the form of chalk, whiting, and limestone) has long been recognized as a useful additive for plastics, including thermoplastics, with ground calcium carbonate being a commonly used filler.

Compared to conventional sources of calcium carbonate, precipitated calcium carbonate (PCC) has an inherently much smaller and uniform size and a more rounded surface morphology. It is thought that the regular and controlled crystalline shape and fine particle size of PCC combine to benefit both polymer processing and subsequent physical properties of the plastics, including resistance to impact and improved weatherability.

Although the use of precipitated calcium carbonate is known in the plastics/bio-resins arts, the materials of the present invention represent a significant improvement to such materials when used as an additive in plastics, resins or elastomers.

It is also known to use calcium phosphate as an additive in plastics. For example, different forms of calcium phosphate are proposed for use as fillers in plastic materials. The different forms of calcium phosphate, including, for example, dicalcium phosphate, tricalcium phosphate and tetracalcium phosphate, have different properties and may afford plastics, resins and elastomers improved properties.

According to a first aspect of the invention, an additive is provided comprising a combination of calcium salt and organic material, wherein the calcium salt is calcium carbonate, calcium phosphate or a combination thereof. In some embodiments, the combination of calcium salt and organic material is a mixture. In some embodiments, the combination is an intimate mixture of calcium salt and organic material. In some embodiments, at least some of the organic material is intimately bound to the calcium salt.

In some embodiments, calcium carbonate, and preferably precipitated calcium carbonate, is combined with organic material to form a mixture. In alternative embodiments, the calcium carbonate is precipitated in the presence of the organic material, so that the organic material becomes intimately mixed with the calcium carbonate or at least partially bound to, associated with or embedded in the calcium carbonate.

In some embodiments, the combination of precipitated calcium carbonate and organic material is derived from steps used in a refining process, such as the refining process of a carbohydrate species such as sugar. The combination formed in this way is referred to herein as calcium carbonate cake (CCC).

In some embodiments, a refining process may be defined as a process which is intended to purify a substance by separating unwanted matter from matter considered to be desirable. Rather than simply separating the unwanted matter from the matter considered to be desirable it may, in some embodiments, be desirable or necessary to capture the unwanted matter using a substance either added in pure form or generated in situ. The unwanted matter taken alone or in combination with the substance used to capture it may be considered to be a by-product or a waste material of the refining process.

For the avoidance of doubt, a refining process is a process of purification and not a process of extraction. For example, in the case of sugar production, the raw sugar must first be extracted from the sugar cane or beet, and this step produces waste sugar cane in the form of substantially insoluble cellulosic material (often described as bagasse or slag) and unrefined raw sugar. The extracted raw sugar may then be subjected to refining or purification using a number of processes such as, but not limited to, affination, carbonatation, phosphatation and crystallisation, with each of the refining steps producing waste materials or by-products.

The sugar refining process typically involves a number of “decolourisation” steps which may be carried out sequentially. The term “decolourisation” is a generic term used in the sugar industry—the removal of impurities from sugar generally results in the sugar become “whiter” as it becomes more refined. The international standard of colour or of relative “whiteness” used in the sugar industry is referred to as the ICUMSA standard (International Commission for Uniform Methods of Sugar Analysis). Low numbers indicate low colour, whilst higher numbers indicate a higher or stronger colour. A good quality white sugar used in the beverage industry may be referred to as having a colour measured as IC 35, a pharmaceutical grade sugar may be IC 20, and a “brown” sugar may have an IC 1000 rating, etc.

As there are a range of “colour species” to be removed in the process of sugar refining, it is often necessary for the practitioner to use primary, secondary and tertiary decolourisation processes—each successive process will remove more or less of the different colour bodies contaminating the sugar. The colour bodies removed at each stage may be differentiated on the basis of a number of factors such as, for example: molecular weight, solubility at different pHs, ionic charge, adsorption coefficient on media such as resins and/or activated carbon, etc.

For the avoidance of doubt, the process of decolourisation does not include the steps of treating the sugar cane to separate bagasse (fibrous matter) from the sugar (which then undergoes decolourisation).

The process of carbonatation may be considered a decolourisation step because it is capable of removing colour bodies from liquids, but it is also capable of removing a huge range of other impurities. Carbonatation is used in a variety of different processes to remove impurities such as, but not limited to, unwanted ions or high molecular weight compounds from liquids. Carbonatation generally involves the addition of a metal or ammonium hydroxide whose carbonate is as least partially insoluble under the conditions employed. Carbon dioxide (CO₂) is also added, resulting in the formation of an insoluble carbonate as a precipitate which may be separated from the liquid, for example by filtration.

During sugar processing or refining, the process of carbonatation is often used to remove impurities from the stream that is being purified. The carbonatation process involves the addition of lime (or variants thereof) to the sugar stream, and the addition of carbon dioxide gas to cause the precipitation of calcium carbonate. The precipitation of the calcium carbonate concomitantly involves the co-precipitation of impurities from the sugar process.

The precipitation of the calcium carbonate is accompanied by the co-precipitation of impurities, such as organic material, that would otherwise be soluble in the liquor, and these impurities may therefore be described as co-precipitates. This process gives rise to the resultant intimate mixture of precipitated calcium carbonate and co-precipitated organic material. For the avoidance of doubt, the term “co-precipitate” is not intended to imply that the organic material is in any particular physical state; it does not necessarily mean that the organic material is in a particulate or even a solid state. For example, the organic material may be trapped within or adsorbed onto the surface of the carbonate.

When the precipitated calcium carbonate is removed from the reaction mixture, it is retrieved in the form of a calcium carbonate cake (CCC). The CCC is an intimate mixture of calcium carbonate and various organic materials. In some embodiments, at least some of the organic material is bound to the calcium carbonate in the CCC.

Optionally, where the term “lime” is used herein this can include the use of dolomitic lime, which is a mixture of MgO and CaO. This will lead to the formation of a precipitate comprising both calcium carbonate and magnesium carbonate. Alternatively, the lime may be replaced with MgO, so that only magnesium carbonate is formed.

Indeed, wherever calcium carbonate or calcium phosphate salts are referenced herein, these may be calcium or magnesium salts respectively.

In some embodiments, there may be benefits associated with the use of calcium carbonate cake from a refining process or step, as this material will comprise a combination of calcium carbonate and organic material and these components will be intimately mixed with or even bound to one another. This means that the additive material comprising CCC will exhibit a uniform mixture of calcium carbonate (which acts as a filler for the plastic or resin) and organic material (which may act as a colorant and/or may have other benefits, as discussed below), and these components remain bound once the additive is added to further materials such as plastics or resin.

There are clearly economic advantages to using CCC to produce the additive of the present invention. The starting material may be a “natural” sustainable product. In some embodiments, the starting material is a co-product of the sugar refining industries (which may be formed in the refining of both cane and beet). Indeed, the CCC is generally considered to be a waste product of such industries. The disposal of the waste CCC may be considered undesirable, particularly due to the high cost and negative environmental aspects associated with the disposal (which may be, for example, disposing of the material in landfill).

In some embodiments, the additive comprises a combination of calcium carbonate, preferably precipitated calcium carbonate, together with organic material and also inorganic material.

For example, in embodiments where the combination of calcium carbonate and organic material is CCC formed as a co-product of a process such as the sugar refining process, the CCC may comprise inorganic material which has been incorporated into the calcium carbonate as the inorganic matter is removed from the sugar stream as a result of the processing step. Like the organic material, this inorganic material may become intimately mixed or associated with the calcium carbonate. In some embodiments, the calcium carbonate is precipitated in the presence of the inorganic material, so that the inorganic material becomes intimately mixed with the calcium carbonate or at least partially bound to, associated with or embedded in the calcium carbonate.

In some embodiments, the inorganic material included in the additive may comprise inorganic salts (commonly referred to as “ash” in the sugar industry), such as calcium phosphate.

In some embodiments, calcium phosphate, and preferably precipitated calcium phosphate, is combined with organic material to form a mixture. In alternative embodiments, the calcium phosphate is precipitated in the presence of the organic material, so that the organic material becomes intimately mixed with the calcium phosphate or at least partially bound to, associated with or embedded in the calcium phosphate.

In some embodiments, the combination of precipitated calcium phosphate and organic material is derived from steps used in a refining process, such as the refining process of a carbohydrate species such as sugar. The combination formed in this way is referred to herein as calcium phosphate product (CPP).

During sugar processing or refining, the process of phosphatation is often used to remove impurities from the stream that is being purified. The phosphatation process may, for example, be used as a decolourisation step, creating a phosphate-containing scum (PCS) including trapped colour bodies and other impurities (as described, for example, in the British patent specification published as GB1224990). The phosphatation process involves the addition of lime and phosphoric acid to a liquor to be decolourised, which causes the precipitation of calcium phosphate. This precipitate or floc can be separated from the liquor, for example by filtration (to produce a calcium phosphate cake or CPC) or by a foaming step to which results in a phosphate-containing scum. The CPC or PCS may comprise a mixture of calcium phosphate and organic matter (for example, ca. 80% by weight organic matter on a solids basis). Herein, CPC and PCS are both referred to by the term calcium phosphate product or CPP.

Both CPC and PCS will be an intimate mixture of calcium phosphate and various organic materials. In some embodiments, in the CPP at least some of the organic material is bound to the calcium phosphate.

In some embodiments, there may be benefits associated with the use of CPP from a refining process or step, as this material will comprise a combination of calcium phosphate and organic material and these components will be intimately mixed with or even bound to one another. This means that the additive material prepared from CPP will exhibit a uniform mixture of calcium phosphate (which acts as a filler for the plastic or resin) and organic material (which may act as a colorant and/or may have other benefits, as discussed below), and these components remain bound once the additive is added to further materials such as plastics or resin.

There are clearly economic advantages to using CPP to produce the additive of the present invention. The starting material may be a “natural” sustainable product. In some embodiments, the starting material is a co-product of the sugar refining industries (formed in the refining of both cane and beet). Indeed, the CPP is generally considered to be a waste product of such industries.

In some embodiments, the additive comprises a combination of calcium phosphate, preferably precipitated calcium phosphate, together with organic material and also inorganic material.

For example, in embodiments where the combination of calcium phosphate and organic material is CPP formed as a co-product of a process such as the sugar refining process, the CPP may comprise inorganic material which has been incorporated into the calcium phosphate as the inorganic matter is removed as a result of the processing step. Like the organic material, this inorganic material may become intimately mixed or associated with the calcium phosphate. In some embodiments, the calcium phosphate is precipitated in the presence of the inorganic material, so that the inorganic material becomes intimately mixed with the calcium phosphate or at least partially bound to, associated with or embedded in the calcium phosphate.

In some embodiments, the inorganic material included in the additive may comprise ash and/or calcium carbonate.

Where reference is made herein to sugar processing this includes beet and cane sugar processing in both the factory and refinery. Other refining processes may also produce a CCC or CPP with an organic component which is suitable for use as an additive according to the present invention, either with or without heat treatment. Such other refining processes include, for example, other carbohydrate refining processes, as well as processes for producing products such as High Fructose Corn Syrup and sweeteners, and wastewater treatment processes.

Many processing methods involve the removal of unwanted components from a starting material. The removed components are frequently present in a waste product, often together with further components which are derived from the starting material or from the process or reaction used in the removal step. Such removal of unwanted components occurs in the processing of crops such as, for example and not limited to, sugar, corn and wheat.

Typically, the waste products are simply disposed of either to a relatively low “land application” in farmers' fields (for pH adjustment) or to land-fill, and increasingly, such disposal represents a burden on the manufacturer. It is therefore one aim of the present invention to transform the waste products into useful, higher value added products. These useful products are referred to herein as co-products or treated products. They are products which have potential value or utility, rather than being by-products or waste products which are simply to be disposed of. In some embodiments, it is a particular aim of the present invention to produce an additive for use in plastics materials and/or resins from a water or co-product of a refining process, such as a sugar refining process or the like.

A significant aspect of sugar processing is the safe, sustainable and economically viable removal of impurities from the sucrose moiety through the use of one or more unit operations designed to remove impurities. In addition, the individual unit operations may produce some impurities and/or by-products which need to be removed. Overall, these impurities may be broadly divided into two classes:
i) Organic impurities; and
ii) Inorganic impurities (including “ash” which comprises salts, etc.).

The organic impurities which may be removed during the processing of the impure (or “raw”) stream may comprise a mixture of organic molecules ranging from low molecular weight carboxylic acids to species such as, but not limited to, higher molecular weight waxes, gums and “colour bodies”.

In some embodiments, the additive comprises precipitated calcium carbonate and/or calcium phosphate in combination with long chain carboxylic acids. It is believed that, at least to some extent, these carboxylic acids are capable of acting as wetting agents or plasticisers. In addition or alternatively, it is believed that the carboxylic acids may act as compatibilisers, enhancing the mixing of components.

The inorganic impurities which may be incorporated into the CCC as a result of the processing of the impure (or “raw”) stream may comprise a mixture of inorganic compounds or species, including inorganic salts such as calcium phosphate and sodium chloride. An analysis of the composition of an example of this type of material is provided in Example 5 below. The impurities are termed “ash” herein. The reference to inorganic material herein is intended to refer to any inorganic material included in the additive which is not calcium carbonate or calcium phosphate.

The inorganic impurities which may be incorporated into the CPP as a result of the processing of the impure (or “raw”) stream may comprise a mixture of inorganic molecules including salts such as calcium phosphate. An analysis of the composition of an example of this type of material is provided in Example 7 below. The impurities are termed “ash” herein. The reference to inorganic material herein is intended to refer to any inorganic material included in the additive which is not calcium phosphate or calcium carbonate.

In some embodiments, the composition of the CCC may be about 70 to about 94% calcium carbonate, with the rest of the CCC comprising organic and optionally inorganic material. In some embodiments, the CCC comprises approximately 80 to 92% calcium carbonate and 20 to 8% of organic and/or inorganic material (although the exact composition will depend on the raw sugar being processed). In some embodiments, the calcium carbonate in the CCC is in the form of precipitated calcium carbonate.

In some embodiments, the composition of the CPP may be about 5 to about 50% calcium phosphate, with the rest of the CPP comprising organic and optionally inorganic material. In some embodiments, the CPP comprises approximately from about 10 to about 20% calcium phosphate and from about 90 to about 40% (respectively) of organic and/or inorganic material (although the exact composition will depend on the raw sugar being processed). In some embodiments, the calcium phosphate in the CPP is in the form of precipitated calcium phosphate.

The proportions of the calcium salt and organic material included in the additive of the present invention may be adjusted to provide the additive with desired properties. In some embodiments this may, for example, be achieved by adjusting the processing step used to produce the CCC or CPP. However, it may be easier and/or more convenient to add organic or inorganic material to the CCC or CPP to adjust the proportions of the various components. In some embodiments, the organic component may be increased and/or modified and the inorganic components any be increased and/or modified, for example by adding other “waste streams” from the sugar processing. Such other water streams may include, for example, the nanofiltration or diafiltration retentate referred to in the International patent application published as WO 2013/093444. This stream contains sodium chloride which may impart desirable properties in some instances, as well as other organic bodies which will also enhance the organic composition. Other suitable sugar processing “waste” streams may also be incorporated as required (for example rejected, contaminated or unprocessable sugars.

In some embodiments, the ratio of calcium salt to organic material in the additive may be from about 99:1 to about 1:99. In some embodiments, the ratio is from about 99:1 to about 40:60.

In some embodiments, the combination of calcium salt and organic material, such as CCC, comprises up to 99% calcium carbonate. In some embodiments, the additive comprises up to about 98%, 97%, 96%, 95%, 94%, 93%, 92%, 91%, 90%, 85%, 80%, 75%, 70%, 65%, 60%, 55% or up to about 50% by weight calcium carbonate. Additionally or alternatively the additive comprises at least about 1%, 5%, 10%, 15%, 20%, 25%, 30%, 35%, 40%, 45%, 50%, 55%, 60%, 65%, 70%, 75%, 80%, 85%, 90%, 91%, 92%, 93%, 94% or at least about 95% by weight calcium carbonate.

In some embodiments, the combination of calcium salt and organic material, such as CPP, comprises up to 99% calcium phosphate. In some embodiments, the additive comprises up to about 98%, 97%, 96%, 95%, 94%, 93%, 92%, 91%, 90%, 85%, 80%, 75%, 70%, 65%, 60%, 55% or up to about 50% by weight calcium phosphate. Additionally or alternatively the additive comprises at least about 1%, 5%, 10%, 15%, 20%, 25%, 30%, 35%, 40%, 45%, 50%, 55%, 60%, 65%, 70%, 75%, 80%, 85%, 90%, 91%, 92%, 93%, 94% or at least about 95% by weight calcium phosphate.

In some embodiments, the combination of calcium salt and organic material, such as CPP and/or CCC, comprises up to 99% organic material. In some embodiments, the additive comprises up to about 98%, 97%, 96%, 95%, 94%, 93%, 92%, 91%, 90%, 85%, 80%, 75%, 70%, 65%, 60%, 55% or up to about 50% by weight organic material. Additionally or alternatively the additive comprises at least about 1%, 5%, 10%, 15%, 20%, 25%, 30%, 35%, 35%, 40%, 45%, 50%, 55%, 60%, 65%, 70%, 75%, 80%, 85%, 90%, 91%, 92%, 93%, 94% or at least about 95% by weight organic material.

In some embodiments, the additive comprises up to about 25%, about 20%, about 15%, about 10%, about 5%, about 4%, about 3%, about 2% or up to about 1% inorganic material (excluding the calcium carbonate and calcium phosphate).

Where the additive comprises a combination of calcium carbonate and calcium phosphate, the ratio of these may be from about 1:99 to about 99:1. In some embodiments, the ratio may be from about 20:80 or 40:60 to about 80:20 or 60:40. In some embodiments, the ratio of CCC to CPP is about 90:10.

For the sugar processor, it is important to recover as much of the sugar as possible from the precipitated calcium salt so the calcium salt is typically filtered, washed with water and partially dried in a filter press. There is an economic balance to be struck in the washing step and typically the CCC or CPP can, for example, comprise approximately from about 0 to about 15% by weight sugar (and this would form part of the organic material described above), although this can be varied.

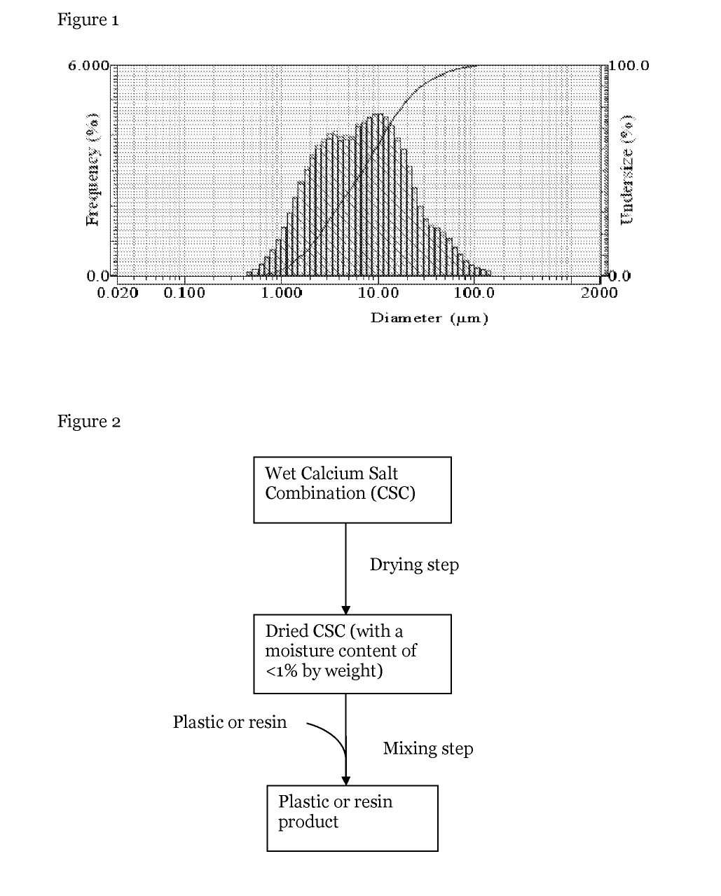

Following a carbonatation step, the filtration and partial drying process, the result is a co-product which may be described as wet CCC. The inventors have surprisingly found that the wet CCC can be economically dried to produce an additive which can be utilised to good effect in the plastics and resins industries. The dried CCC has a particle size and morphology which renders it suitable for inclusion in plastics and resins as an additive. The particle size distribution of the dried CCC is shown in the graph of FIG. 1. The particle size of the CCC is generally between about 0.4 μm and about 150 μm, with the majority of the particles having a size between about 1 and about 50 μm. Without wishing to be bound by theory, it is thought that the more rounded and uniform the particle shape of the additive, the more resistant the final plastic or resin is to crack propagation and the like.

The particle size and morphology of the additive may be tailored by altering the conditions employed in the process used to produce it. For example, in the case of a carbonatation process which produces CCC, the concentration of carbon dioxide gas, the residence time of the PCC in the reaction vessel and the pH of the liquor in the reaction vessel will all have an effect on the characteristics of the particles which make up the CCC. By adjusting these parameters the particle size and morphology of the additive may be tailored to provide a CCC having particle characteristics which make it particularly suitable for inclusion in plastics and resins.

According to a second aspect of the invention, a method of manufacturing an additive according to the first aspect is provided.

In some embodiments, as illustrated in FIG. 2, the additive may be formed by simply drying a combination of calcium salt and organic material which is in the form of CCC or CPP, referred to herein as calcium salt combination or CSC. In some embodiments, the CSC comprises or consists of CCC, CPP or a combination thereof.

The dried CSC may, in some embodiments, be used without further treatment or processing. In some embodiments, the drying step may reduce the moisture content in the dried CSC to no more than about 5%, no more than about 4%, no more that about 3%, no more than about 2% or no more than about 1%. In some embodiments, the drying step may involve exposing the wet CSC to elevated temperatures to encourage the evaporation of the water. In some embodiments, this drying step does not involve heating the wet CSC to a temperature above 50° C., and indeed drying may be completed at lower temperatures over a longer period of time if/as required.

In some embodiments, it may be desirable to gradually increase the drying temperature over a period of time. For example, in some embodiments, it may be desirable to gradually increase the temperature from ambient up to the maximum desired drying temperature in a time period of less than about 5, 10, 15, 20, 25, 30, 35, 40, 45, 50, 55, 60, 80, 100, 120 minutes. In some embodiments, the drying temperature may be increased at any desired rate, for example a rate of about 1, 2, 3, 4, 5, 6, 7, 8, 9, 10, 20, 30, 40, 50 or 60° C. per minute.

In some embodiments, it may be desirable and/or convenient not to dry the CSC prior to its use as an additive. In some embodiments, the undried CSC may be used as an additive for plastic, resin and elastomer compositions. In particular embodiments, the undried CSC may be particularly suitable for addition to resin compositions. In some embodiments, the CSC may be in a slurry or cake form when combined with the plastic, resin or elastomer. In some embodiments, use of undried CSC as an additive may result in a superior composition compared with using dried CSC. The omission of the drying step will also result in a process which is more economical and environmentally friendly, with less energy and labour being required to produce the additive material.

This material has an organic component which provides some colour. For example, in some embodiments, the CSC may be formed in a processing step, such as a carbonatation step, in which the calcium carbonate is formed and traps colour bodies and/or other coloured components from the reaction mixture. This untreated, dried CCC has an organic component which can afford the plastic or resin with a brown colour when used as an additive, in combination with the additive being a filler. These embodiments may be particularly useful for use in the manufacture of brown plastics or resins, and in plastics or resins where there is a desire to impart some natural dye colouring.

In some embodiments, it may be desirable to produce an additive material which is substantially devoid of colour. This may be achieved, for example, by treating the CSC to remove the high-coloured organic components so as to produce a substantially whitened CSC. Whitened CSC may be particularly useful as an additive for use in the manufacture of white, frosted or even translucent materials.

The source of the CSC will determine what other components might be present. Where the CSC is formed as part of a refining process, such as a carbonatation step in sugar refining, the CCC may include, in addition to the calcium carbonate and organic components, waxes and carboxylic acids that the sugar carbonatation process removes. The presence of some of these components may have further benefits. For example, it is considered that these components may, in some embodiments, further contribute to the beneficial nature of the additive of the present invention, as the waxes and carboxylic acids may act as compatibilisers, assisting the mixing of the plastic or resin with the additive and other components.

The CSC derived from the sugar refining process may also include some residual sugar and it is believed that this sugar component of the additive may itself impart some beneficial properties to the additive. In some embodiments, the residual sugar in the additive may contribute to the production of a desirable aroma when the additive is added to the plastic or resin, as it may caramelise during processing. This may also contribute to the additive providing the plastic or resin with further colour.

In some other applications (for instance where the plastic is to be used in a confined space with limited ventilation—such as inside a car) the presence of an odour emanating from the plastic may not be desirable and so, in some embodiments, the CSC may undergo further washing, for example with hot water or water which has been pH adjusted (for instance to maximise efficient removal of specific moieties) prior to drying to remove sugar and any other components which may contribute to an odour associated with the CSC and/or a plastic comprising the CSC which may be felt to be undesirable. In some embodiments, the CSC may be washed with an acid or a base.

The charring process, which is described later on herein, may also help to mitigate and/or eliminate any undesirable odours. Without wishing to be bound by any particular theory, it is believed that the odorous molecules associated with the CSC are lower molecular weight (and hence potentially more volatile) and these species (along with ash) are most readily “washed out” of the CSC. In contrast, the simple washing of CSC does not remove the colour bodies, which are believed to be: (a) higher molecular weight; and (b) bound to the CSC. Also, the analysis data for Examples 7 and 8 presented in Tables 10 and 13 show the effects of charring on the sugar content. Alternatively or in addition the CSC may be combined with odorous chemical compounds and such odours may be considered to be particularly pleasant or they may have the ability to neutralise or mask other unpleasant odours.

In some embodiments, the dried CSC comprises precipitated calcium carbonate and the particles of calcium carbonate have a rounded shape which has benefits for certain applications, including for the use as a filler for plastics and resins.

In some embodiments, the dried CSC comprises precipitated calcium phosphate and the particles of calcium phosphate have a rounded shape which has benefits for certain applications, including for the use as a filler for plastics and resins.

The additives of the present invention have been found to be particularly effective when used as fillers for resins. When used in this application, the final resinous materials have unexpectedly been found to exhibit superior properties, such as, for example greater strength, compared with materials which use conventional fillers, or no fillers at all. Without wishing to be bound by theory it is thought that the organic content of the additive component may interact or cross-link with the resin, which results in a substantially stronger material.

Although the particle size distribution of the dried CSC is already suitable for use as an additive material in many applications, in some embodiments, the particle size may be adjusted in order to prepare the additive material of the present invention. For example, adjusting the particle size may allow the surface area:volume ratio of the dried CSC to be increased.

In some embodiments, the particle size adjustment may involve a grinding or milling step. In some embodiments, the grinding or milling step may by used to reduce the particle size of the dried CSC with a finer and/or more specific particle size distribution. A sieving step may also be used to ensure that particles within a particular size range are selected for use.

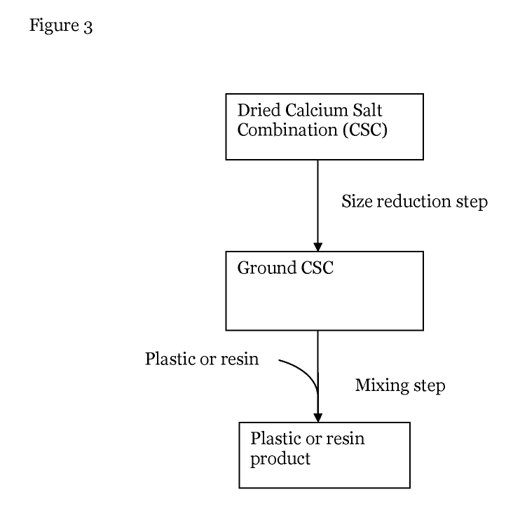

The process illustrated in FIG. 3 includes a size reduction step. This may be a milling or grinding step and it results in a product with a reduced particle size. In the illustrated process the size reduction step is applied to a dried CSC. In an alternative embodiment, wet CSC may undergo the size reduction step before subsequently being dried. The wet milling may assist in the size reduction and in obtaining particles of the desired size range. Optionally, the CSC need not be totally dried as it can be added to other very dry (ca. 100%) components of the mix for the plastic and provided that the overall mix is ca. 99% dry on solids basis that will suffice for the plastic processing.

The particle size and morphology of the additive material formed from CSC is beneficial for use as an additive in plastics or resins. A variety of particle sizes of the additive may be suitable for use in plastics or resins, for example, a suitable additive particle size may depend upon the desired properties of the resultant plastic material. In some embodiments, the particle size of the additive may be about 0.1 to about 100 μm which, in some embodiments may require no particle size adjustment step. In other embodiments, the CSC may be milled so that the additive has a reduced particle size compared to the CSC starting material from which it is formed. In some embodiments, the particle size of the additive may be in the range from about 0.1, 0.05 or 0.01 μm, to about 80, 50, 40, 30, 20, 10 or 1 μm. Alternatively, the particle size of the additive may be controlled by tailoring the operating conditions of the process used to make it.

In some embodiments, the additive is milled to provide particles which are as fine as economically desirable, even down to the size of nano-scale particles. Such fine particles may perform well as additive when added to a plastic or resin, affording the plastic or resin with good physical and chemical characteristics and having good processing properties.

In yet further embodiments, the CSC may undergo alternative or additional processing steps. In some embodiments, the CSC may be washed. Such a washing step can, for example, remove more sugar or other contaminants, such as sulphates. The CSC being washed may be wet CSC, or it may be dried and/or otherwise treated CSC.

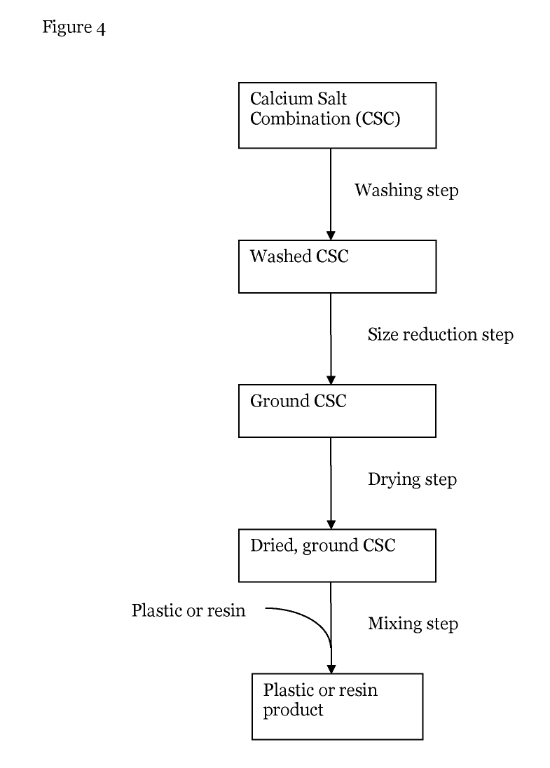

In the embodiment illustrated in FIG. 4, the CSC is washed and the wet washed product is then milled or otherwise treated to adjust the particle size, before being dried to produce dried, ground CSC.

The steps of washing, drying and milling the CSC may be combined in different sequences to produce additive materials with characteristics specifically tailored to the proposed use of the additive material. For example, odour removal or mitigation could be practised after the milling process. In some embodiments, the milling can expose more volatile molecules, so that subsequent washing may be preferred.

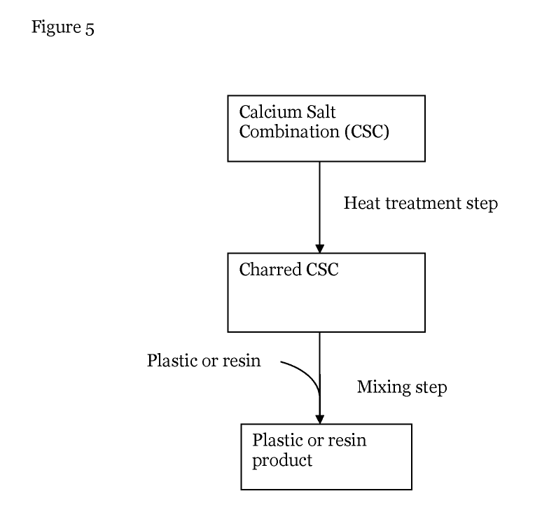

In some embodiments, the treated CSC may undergo further treatment. For example, the treated CSC may be heat treated, as discussed in greater detail below. A simple process for treating CSC which involves a heat treatment step is illustrated in FIG. 5.

In the illustrated process, the CSC is heat treated to produce a “charred product”. The meaning of the term “charred” is discussed further below. It is a general indication that the organic material in the CSC has undergone a change as a result of the heat treatment. The extent of that change varies, depending upon the nature of the heat treatment step.

The effect of charring on the composition of the CCC and CPS discussed herein is shown in Examples 6 and 8 (in particular, when compared to Examples 5 and 7, respectively). These Examples include an analysis of the composition of charred samples which is changed by the charring process.

The CSC which is heat treated may be dried CSC. Alternatively, the material being heat treated may be wet CSC, with the initial phase of the heat treatment effectively resulting in the CSC being dried. Usually, in such circumstances, the heat treatment of the wet CSC will not result in a change in the organic material until the CSC has been sufficiently dried for the heat to have the necessary effect on the organic material.

Thus, in some embodiments of the present invention, the additive comprises heat treated organic material. In some embodiments, the heat treatment leads to the formation of carbon, a charred material or a partially charred material and/or a carbonised material.

In some embodiments, the additive is prepared by heat treating CSC, the resultant additive material exhibits a uniform mixture of calcium salt and heat treated organic material. In some embodiments, the heat-treated organic material comprises carbon or a partially charred or charred or carbonised organic component.

The heat treated organic material will generally tend to be darker in colour than the organic component prior to heat treatment. Depending upon the extent of the heat treatment, the organic material may be brown, dark brown or black in colour and this component will allow the additive to act as a colorant when used in plastics or resins.

In some embodiments, the “charring” process of CCC may be taken to such lengths that a significant proportion, if not all, of the organics are “burnt off” and the CCC returns to a cream, grey or “off white” colour. In some embodiments, some calcination occurs as well so that the final product could contain a mixture of calcium carbonate and calcium oxide.

The charred material or partially charred material and/or the carbonised material may have a structure which confers on the material the ability to adsorb odours. Such charred, partially charred or carbonised materials may beneficially adsorb odours emitted from other components of the final composition.

In some embodiments, the organic material may be heat treated whilst in combination with the calcium salt. In such embodiments, the components may remain bound or may become more bound. In addition, in some embodiments, the heat treated components may remain bound or intimately mixed when the additive is added to the plastic or resin, optionally with other materials.

In further embodiments, charring may be achieved by adding a very concentrated acid (e.g. concentrated sulphuric acid, such as “oleum”) to chemically dehydrate and char the CSC.

Depending on the temperature, time and atmospheric conditions used in the heat treatment of the organic material, further experimentation has shown that a range of products can be produced, including, for example:
1) Partially charred organic material (in some embodiments with some of the organic material possibly being caramelised) but the organic material not being fully converted to carbon (in some embodiments with the charred organic material still being strongly chemically bound to the calcium salt);
2) Fully charred so that at least some of the organic material is completely converted into carbon (in some embodiments with some of the carbon still intimately physically bound to the calcium salt, although it may be possible that some of the carbon may be removed, for example due to its increased friability), and in some embodiments essentially all of the organic material is converted into carbon. In some embodiments, the carbon is pure carbon black.
3) Fully charred and partially calcined, so that at least some of the calcium carbonate, when present, is also transformed by the heat treatment. In some embodiments, there may be some benefits in partially calcining the CaCO₃ to CaO, to increase the basicity of the product.

In some embodiments, the charring of the CSC is superficial and affects substantially only the organic material on the surface of the CSC. In such embodiments, the remaining organic material may contribute to the properties and function of the additive material. For example, as discussed above, the uncharred organic material may include carboxylic acids which may act as wetting agents or plasticisers. The charred organic material may be present in the form of black carbonized material which can act as a colorant. Thus, depending upon the extent of the heat treatment and the charring, the additive may include some uncharred organic material which may have beneficial properties, and some charred organic material, which may have beneficial properties.

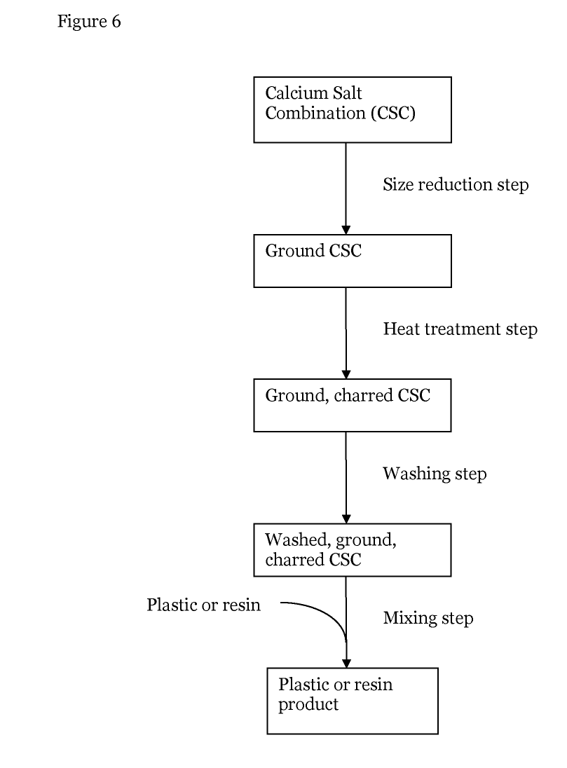

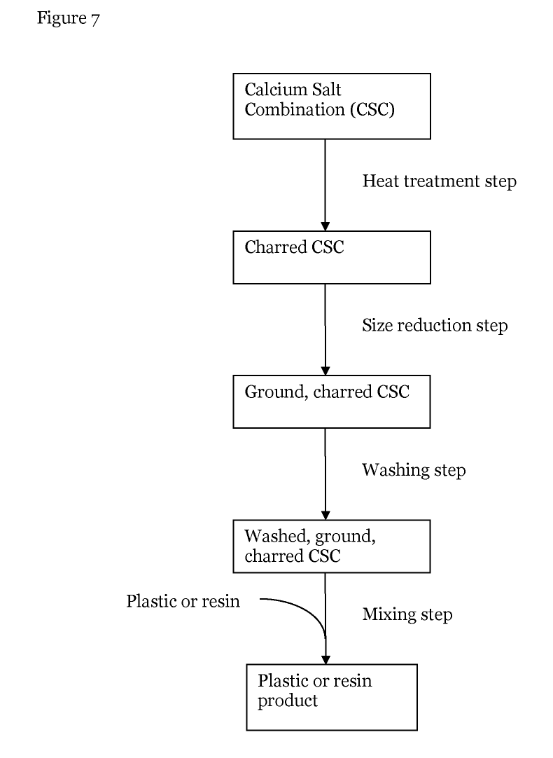

The extent of charring may, in some embodiments, be controlled by the sequence of steps processing the CSC. If the processing includes a particle size reduction step, this may be carried out before the heat treatment step to increase the amount or extent of charring of the organic material. This sequence of steps is illustrated in FIG. 6. Alternatively, reducing the particle size after heat treatment may ensure that at least some organic material is not affected by the heat treatment but is then subsequently exposed when the additive is ground, to enhance the effects of the uncharred organic material on the properties of the additive and/or on the plastic or resin. This sequence of steps is illustrated in FIG. 7.

Charring is a chemical process of incomplete combustion of certain solids when subjected to high heat under a controlled atmosphere. The resulting residue matter is called char. By the action of heat, charring removes hydrogen and oxygen from the solid, so that the remaining char is composed primarily of carbon. Most solid organic compounds exhibit charring behaviour.

In some embodiments, the formation of the additive involves charring or carbonisation. Traditional carbonisation is where a starting material with carbon content (for example, the organic matter) is pyrolysed at temperatures in the range 600-900° C., in the absence of oxygen (usually in inert atmosphere with gases like argon or nitrogen).

In some embodiments, the material to be heat treated may be in a dry or dried form, or it may be in the form of a paste. Where the material is a paste, the moisture may be present in the waste product as it is formed. Alternatively or in addition, water may be added to produce a paste with the desired properties such as moisture content, consistency, etc.

In some embodiments, the material to be heat treated may be processed to ensure that it is in a suitable and/or desired form (for example, size and shape) before being heat treated. In some embodiments, this may involve grinding the material or otherwise changing the particle size. In some embodiments, the material to be heat treated may be extruded, and this may be a preferred embodiment where the material is in the form of a paste. In certain embodiments, the material may be heat treated and then processed into the desired form.

In embodiments where the material to be heat treated is extruded, this step may also apply the heat required to treat the material and form the heat treated material. Extrusion processes may be controlled to expose the material being extruded to an elevated temperature for a predetermined period of time and, in some embodiments, the temperature and time period may be selected to ensure that the material, and in particular the organic matter in the material, is transformed to produce a treated material with the desired properties, such as the desired extent of charring or carbonisation.

In other embodiments, the material is heat treated in a furnace or oven, or it may pass through or be held in an area where it is exposed to elevated temperatures. Optionally, techniques such as microwave heating (with the material passing through the microwave cavity on a conveyor) can be used to control the level of charring. Heating and charring techniques are well known in the art and these techniques can be used to provide optimal moisture content, residual volatility and optimal extent of charring/carbonisation. In some embodiments, the material is heated in a furnace or an oven under controlled atmospheres (from inert to air to enriched in oxygen). In some embodiments, it may be desirable to utilise the residual heat produced, for example, by existing onsite boilers in the heat treatment step.

The precise temperature and/or duration of the heat treatment step will depend upon the properties of the material to be heat treated (the starting material) and/or upon the desired properties of the material once treated (the treated material). For example, if the starting material has a high moisture content, such as where the starting material is a paste, the heat treatment step is likely to require a higher temperature or a longer duration in order to produce the desired transformation (such as carbonisation) of the organic matter.

In some embodiments, it may be desirable to gradually increase the temperature used in the heat treatment step over a period of time. For example, in some embodiments, it may be desirable to gradually increase the temperature from ambient up to the maximum desired heat treatment temperature in a time period of less than about 5, 10, 15, 20, 25, 30, 35, 40, 45, 50, 55, 60, 80, 100 or 120 minutes. The rate of temperature increase will substantially depend on the nature of the heating device. For example, some heating devices (e.g. microwaves heaters) may increase the temperature of the material more rapidly than other heating devices. In some embodiments, the temperature used in the heat treatment step may be increased at any desired rate. For example, in some embodiments, the temperature may be increased at a rate of about 1, 2, 3, 4, 5, 6, 7, 8, 9, 10, 20, 30, 40, 50 or 60° C. per minute.

In some embodiments, the heat treatment step involves exposing the starting material to a temperature of at least 200° C. In some embodiments, the temperature is at least about 200, 250, 300, 350, 400, 450, 500, 550, 600, 650, 700, 750, 800, 850, 900 or at least about 95° C. Additionally or alternatively, the temperature is no more than about 1200, 1150, 1100, 1050, 1000, 950, 900, 850, 800 or no more than about 750° C.

In some embodiments, the heat treatment step involves exposing the starting material for a period of at least 20 minutes. In some embodiments, the period of exposure to the elevated temperature is at least about 20 minutes, 25, 30, 45, 60, 90, 120, 150, 180, 240, 300, 360, 420, 480, 540, or at least about 600 minutes. Additionally or alternatively, the period of exposure to the elevated temperature may be no more than about 1200 minutes, 900, 800, 700, 600, 540, 480, 420 or no more than about 300 minutes.

The properties of the additive material (for example, its strength, rigidity and toughness) may be affected by the process used to cool the treated material after heat treatment.

In some embodiments, the material may be cooled by separating the material from the heat source and allowing it to gradually cool to ambient temperature. Alternatively, the temperature of the material may be rapidly cooled, or quenched, be exposing the material to lower temperatures. For example, the material may be quenched by submerging it in a fluid having a lower temperature.

In some embodiments, the rate of cooling may be carefully controlled by gradually decreasing the temperature over a period of time. Alternatively, or in addition, the temperature may be reduced over time at different rates over a series of steps. At any step the temperature may be held for a certain period of time before reducing the temperature further.

Optional further processing of the treated material may involve activation (which may also be referred to as oxidation). The treated material, optionally including carbon formed by charring or carbonisation, is exposed to oxidizing atmospheres (oxygen or steam) at temperatures above 250° C., and usually in the temperature range of 600-1200° C. It may, in some embodiments, be desirable to treat the material using the steam produced as a result of existing onsite processes.

Just as described above for the dried CSC, the heat treated CSC can, in some embodiments, be optionally washed, milled, deodorised and/or dried to give additives with a range of properties.

In some embodiments, the combination of precipitated calcium salt and organic material further comprises other material, such as, for example, inorganic material. In some embodiments, this other material may derive from the process leading to the formation of the CSC, as discussed above. Alternatively or in addition, the other material may be added to the CSC or alternatively derived calcium salt and organic material. In some embodiments, the added material may comprise one or more waste products. For example, these may be different waste products from different parts of the process which produces the CSC. This may be combined with the combination of calcium salt and organic material. In some embodiments, the added material is intimately mixed with the combination. In some embodiments, at least some of the added material may be associated with or bound to the calcium salt and/or organic material.

In some embodiments, adjusting the proportions of the calcium salt, organic material, and any other components of the additive allows the properties of the additive to be controlled or adjusted. For example, in some embodiments, the amount of the organic component in the additive will affect the colorant effect of the additive in the plastic or resin.

In some embodiments, the other material included in the combination of calcium salt and organic material is inorganic material. In some embodiments, an additional, inorganic material may be included in the additive. Alternatively or in addition, the inorganic material already present in the CSC.

In some embodiments, the inorganic material in the CSC may include, for example, residual NaCl, ash, colorants and other residues. These inorganic materials may have a beneficial effect on the properties of the plastics materials to which the additive may be added. For example, in some embodiments, the inorganic material may provide a high strength support for the additive and/or the plastic or resin into which it is incorporated.

In some embodiments, the additive made from a combination of calcium salt and organic material with a low inorganic matter content may have a low specific gravity and this could lead to dust or contamination problems when the additive is employed. The presence of inorganic matter in the additive can, in some embodiments, have an “anchoring” effect, especially where the organic material is heat treated, increasing the overall specific gravity of the additive material which can mitigate these issues to some extent.

To those skilled in the art, it will be apparent that the additives of the invention may be used on their own or optionally they can be mixed with other components, such as other additives, to provide optimal properties for a plastic or resin. In particular, the calcium salt component of the additive acts as a filler, whilst the organic component acts as a colorant. Particular benefits are seen where these components are associated with one another and remain associated when the additive is used. In some embodiments, further components of the additives of the invention can enhance these effects and/or can provide additional benefits, such as acting to compatibilise the mixture or organic and inorganic components.

Furthermore, in some embodiments, the additives (and/or admixtures thereof) can provide a sustainable source of additives for the plastics and resins industry. In particular, the additives represent sustainable fillers and optionally colorants.

According to a third aspect of the invention, the use of an additive according to the invention is provided, to provide a plastic, resin or elastomer composition. Preferably, the use of the additive will provide the composition with improved properties. In some embodiments, the beneficial properties are associated with the additive being a homogenous mixture of components, in particular of filler and colorant. The additive may also or alternatively include other components, such as plasticisers and compatibilisers.

In some embodiments, the additive materials disclosed herein may also be used as components or fillers in composite materials. Such composite materials may comprise a variety of other constituent materials, such as plastics, resins, elastomers, cellulosic materials (including paper, cardboard, hemp, flax or other fibres) and/or other synthetic or natural materials. In some embodiments, the additive may be added to any of the constituent materials that make up the composite material. In particular embodiments, the additive is added to the resinous component of the composite material. Compared with non-composite materials, composite materials may exhibit properties which are often seen to be particularly desirable, for example they may have a high strength-to-weight ratio, the ability to resist deformation and they may have particularly good sound and heat insulating properties.

According to a fourth aspect of the invention, a process for preparing a plastic, resin or elastomer composition is provided, wherein the process comprises mixing a plastic, resin or elastomer starting material with an additive according to the invention.

A benefit associated with the use of the additive of the invention is that this means that the composition does not need to include further additives such as colorant or pigment. This is because the organic material or charred organic material will have the effect of a colorant. In addition or alternatively, the organic material may provide the additive of the invention with properties such as plasticising and/or compatibilising, so that further additives to provide such effects are not needed.

According to a fifth aspect of the invention, plastic, resin or elastomer compositions are provided comprising an additive of the invention.

In some embodiments, the plastic, resin or elastomer composition comprises between 1 and 99% additive based upon the total weight of the composition. In some embodiments, the composition includes at least about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95% or at least about 99% additive, based on the total weight of the composition. In some embodiments, the composition includes no more than about 95%, about 90%, about 85%, about 80%, about 75%, about 70%, about 65%, about 60%, about 55%, about 50%, about 45%, about 40%, about 35%, about 30%, about 25%, about 20%, about 15%, about 10% or no more than about 5% additive, based on the total weight of the composition. In some embodiments, the plastic, resin or elastomer composition comprises between 10 and 90% additive based upon the total weight of the composition, between 20 and 80% additive based upon the total weight of the composition, between 25 and 75% additive based upon the total weight of the composition, between 30 and 70% additive based upon the total weight of the composition, or between 40 and 80% additive based upon the total weight of the composition.

The additive used in the compositions may be any of the additives described herein or produce by processes described herein.

According to some aspects of the invention, an article may comprise or consist of a plastic, resin or elastomer comprising an additive according to the present invention. In some embodiments, an article may comprise further plastic, resin or elastomer.

For example, in some embodiments, the article may comprise a plastic, resin or elastomer comprising an additive according to the present invention, which is at least partially covered by or surrounded by a further plastic, resin or elastomer. Such an article may comprise a significant proportion of lower quality and/or cheaper material, for example comprising recycled plastic and an additive of the present invention, this material being at least partially covered or surrounded by a higher quality and/or more expensive plastic, resin or elastomer, such as one made from virgin plastic and/or virgin additive. This can provide the article with a high quality appearance, the further plastic, resin or elastomer providing what is essentially a veneer on the surface of the article.

In other embodiments, an article may comprise two or more layers of different plastic, resin or elastomer compositions. For example, the layers may comprise different plastic, resin or elastomer, and/or different additives and/or different amounts of additives. The layers may be selected to give the product desired physical or chemical properties. In some embodiments, the layers may be laminated to one another.

### EXAMPLES

### Example 1

### CCC and Recycled High Density Polyethylene

10 kg of granules of recycled HDPE (made from washed and processed plastic milk bottles) were compounded with 10 kg of dried CCC from the sugar refining process.

The materials were compounded using a co-rotating intermeshing twin screw extruder and the extrudate was granulated and compression moulded using heated platens for 10 minutes. The compound was placed in a compression mould and heated to a temperature of ca. 150° C. for 10 minutes. A film of brown plastic was produced. This plastic material was a 50:50 mix of recycled HDPE and sustainable CCC and would appear to have good physical properties for some useful applications.

The plastic sheeting had a “natural” brown colour and it could be useful in applications such as plastic lumber, packaging, etc.

### Example 2

### CCC and EPDM

Compounding of ethylene propylene diene monomer (EPDM), which is an elastomer, and CCC was done by co-extrusion of the CCC and the EPDM to give a range of compounds with different % weights of CCC as follows:

TABLE 1

| Batch # | CCC Content (% weight) from calibration |
|---|---|
| 1 | 39 |
| 2 | 43 |
| 3 | 51 |
| 4 | 56 |
| 5 | 60 |
| 6 | 64 |

These compounds were extruded and it was seen that the extrudate from Batch 1 was a brown polymeric mass with no powdery coating, whereas the extrudate from Batch 6 was a brown polymeric mass with a loose powdery coating of CCC. Intermediate batches showed intermediate results—that is: there is a visible trend from 39% CCC by weight to 64% by weight.

When the compounds were compression moulded, similar observations were made. These results lead to the conclusion that CCC did not blend well with EPDM at the higher % concentrations, but behaved well when included in an amount of up to around 39%. It was speculated that inclusion of a plasticiser may improve the blending of CCC with EPDM.

### Example 3

### Effect of Plasticiser

Trials were carried out using a plasticizer, namely Plastisol, which is a suspension of PVC particles in a liquid plasticizer. The Plastisol was obtained from the wallpaper manufacturing industry. It was considered to be a waste product since it had colouration from an end of PVC wallpaper processing line.

CCC was pre-blended with the plasticizer in a high speed rotary mixer. Mixing was rapid and the mixture appeared to be homogeneous. This pre-blend was than added to the EPDM or EVA.

### 1) EPDM/CCC/Plasticizer

The materials were compounded using the following weight % ratios:

| Material | % Weight Ratio |
|---|---|
| EPDM | 19 |
| CCC | 75 |
| Plasticizer | 6 |

It was noted that the addition of plasticizer resulted in a more intimately blended mixture of EPDM and CCC—there was no loose powdered CCC on the surface of the extruded material.

### 2) EVA/CCC/Plasticiser

The materials were compounded using the following weight % ratios:

| Material | % Weight Ratio |
|---|---|
| EVA | 19 |
| CCC | 75 |
| Plasticizer | 6 |

It was noted that the CCC blended homogeneously with the plasticizer and the EVA.

This work suggested that the inclusion of a plasticiser does, as predicted, improve the blending of CCC and EPDM. The same homogenous blending was also observed in a mixture of CCC and EVA in the presence of a plasticiser.

In some trials, barium sulphate (BaSO₄) was also included in the compositions. In some plastics, such as polypropylene and polystyrene plastics, BaSO₄ is used as a filler in proportions up to 70%. It has an effect of increasing acid and alkali resistance and opacity. The BaSO₄ used in experiments was Portaryte D₅₀. CCC was pre-blended with the plasticizer and BaSO₄ in a high speed rotary mixer. Mixing was rapid and the mixture appeared to be homogeneous. This pre-blend was than added to the EPDM or EVA.

In all the examples above, the CCC (which has been dried to <1% moisture) could be replaced by “charred” or “carbonized” to give a polymer compounding material which is simultaneously a relatively inexpensive mineral filler as well as a provider of intimately mixed “carbon black”.

### Example 4

### Extrusion Compounding of PP with Calcium Carbonate Cake

Experiments were carried out to determine the compatibility between polyolefins with CCC.

A 40 mm 21:1 L:D ratio co-rotating intermeshing twin screw extruder was used to blend PP with CCC, using a screw speed of 200 rpm and the following temperature profile:

| Barrel | 1 | 2 | 3 | 4 | 5 | Die |
|---|---|---|---|---|---|---|
| ° C. | 160 | 170 | 180 | 190 | 190 | 190 |

The PP polymer granules were fed in at feed port 1 using a volumetric feeder and the CCC, which was pre-dried in an air-circulating oven set at 75° C. for 12 hours, was fed using a second volumetric feeder again at feed port 1.

The feed rate for the CCC was set at 50%. First the PP was fed through the extruder followed by the combination of 50 wt % PP and 50 wt % CCC. Then, once a steady extrudate was obtained the master batch was collected cooled and compression moulded.

An upstroke compression moulding machine was used to manufacture sheets of the composite approximately 600 μm thick following pre-heating of the platens at 185° C. Sheets of the composite were pressed between steel plates, using 10 minutes of conditioning time and 8 minutes of compression moulding time with 30 tonnes of pressure for the 300×300 mm steel plates.

It was observed that the CCC combined with the PP quite easily, forming a homogeneous compound which could be pelletized or granulated for further processing, and in this case for compression moulding.

During the extrusion blending process there was a characteristic smell coming from the compound which seemed to smell of caramelised sugar (molasses) and the colour of the compound extruded was brown, indicating thermal degradation.

Once the compound was compression moulded it was noticed that the brown colouration darkened, indicating that there was some further thermal degradation of impurities that are present in the CCC. However, the sheeting produced was very flexible and appeared to have good mechanical properties, although there were black striations within the brown sheets produced indicating that some parts of the CCC were more degraded. These striations are extremely desirable in some applications (providing a “marbling” effect) and, to a person skilled in the art, this effect can be created as desired.

### Example 5

### CCC and Recycled High Density Polyethylene

Calcium carbonate cake (CCC) from a sugar refining process was dried in a ring dryer. The dryness of the sample as measured on a moisture balance was determined to be 99%. The composition of this material is given in Tables 2 and 3. The designation “nd” used in this and other Examples means “not detected”.

TABLE 2

| Cations | Content (ppm on solids basis) |
|---|---|
| Ca | 332048 |
| Cu | nd |
| Fe | 509 |
| K | nd |
| Mg | 2690 |
| Mn | 115 |
| Na | nd |
| P | 646 |
| S | 8680 |

TABLE 3

| Anions & Acids | Content (ppm on solids basis) |
|---|---|
| Chloride | 20 |
| Sulphate | 136 |
| Phosphate | 1 |
| Oxalate | 123 |
| Citrate | 25 |
| Aconitate | 60 |
| Lactate | 5446 |
| Acetate | 763 |
| Malate | 81 |
| Formate | 533 |
| Nitrate | 11 |

TABLE 4

| Sugars, etc. | Content (% on solids basis) |
|---|---|
| Sucrose | nd |
| Glucose | nd |
| Fructose | nd |

350 g of granules of recycled HDPE (made from washed and processed plastic milk bottles) were compounded with 350 g of the dried CCC.

The materials were compounded using a co-rotating intermeshing twin screw extruder and the extrudate was granulated and compression moulded using heated platens for 10 minutes. The compound was then placed in a compression mould and heated to a temperature of approximately 180° C. for 10 minutes. A film of brown plastic was produced.

This plastic material was a 50:50 mix of recycled HDPE and sustainable CCC and would appear to have good physical properties for some useful applications. The plastic sheeting had a “natural” brown colour (lighter than that in Example 1) and it could be useful in applications such as plastic lumber, packaging, etc.

### Example 6

### Charred CCC and Recycled High Density Polyethylene

The calcium carbonate cake that was used in Example 5 was charred in a muffle furnace. The composition of the charred dried material is given in Tables 5, 6 and 7.

TABLE 5

| Cations | Content (ppm on solids basis) |
|---|---|
| Ca | 335000 |
| Cu | nd |
| Fe | 531 |
| K | nd |
| Mg | 2930 |
| Mn | 127 |
| Na | nd |
| P | 765 |
| S | 8860 |

TABLE 6

| Anions & Acids | Content (ppm on solids basis) |
|---|---|
| Chloride | 12 |
| Sulphate | 457 |
| Phosphate | nd |
| Oxalate | 42 |
| Citrate | nd |
| Aconitate | nd |
| Lactate | 60 |
| Acetate | 4 |
| Malate | nd |
| Formate | 6 |
| Nitrate | 6 |

TABLE 7

| Sugars, etc. | Content (% on solids basis) |
|---|---|
| Sucrose | nd |
| Glucose | nd |
| Fructose | nd |

Similar to Example 5, 350 g of granules of recycled HDPE (made from washed and processed plastic milk bottles) were compounded with 350 g of charred dried CCC from the sugar refining process.

The materials were compounded using a co-rotating intermeshing twin screw extruder and the extrudate was granulated and compression moulded using heated platens for 10 minutes. The compound was placed in a compression mould and heated to a temperature of approximately 180° C. for 10 minutes, a film of black plastic was produced, and a material such as this could be useful in applications such as car bumpers, etc.

### Example 7

### Dried Calcium Phosphate Scum and Recycled High Density Polyethylene

Phosphate scum from two different sugar refineries was dried in the laboratory to give a solid that was 99% dry solids. The solid was ground in a mortar and pestle.

The composition of the dried material is given in Table 8, 9 and 10.

TABLE 8

| Cations | Content (ppm on solids basis) |
|---|---|
| Ca | 179000 |
| Cu | nd |
| Fe | 1610 |
| K | nd |
| Mg | 6410 |
| Mn | 123 |
| Na | nd |
| P | 74200 |
| S | 6300 |

TABLE 9

| Anions & Acids | Content (ppm on solids basis) |
|---|---|
| Chloride | 112 |
| Sulphate | 2321 |
| Phosphate | 19 |
| Oxalate | 254 |
| Citrate | 231 |
| Aconitate | 1212 |
| Lactate | 1946 |
| Acetate | 3316 |
| Malate | 787 |
| Formate | 759 |
| Nitrate | 4 |

TABLE 10

| Sugars, etc. | Content (% on solids basis) |
|---|---|
| Sucrose | 6.9 |
| Glucose | 0.5 |
| Fructose | 0.7 |

350 g of granules of recycled HDPE (made from washed and processed plastic milk bottles) were compounded with 350 g of the above dry calcium phosphate scum.

The materials were compounded using a co-rotating intermeshing twin screw extruder and the extrudate was granulated and compression moulded using heated platens for 10 minutes. The compound was placed in a compression mould and heated to a temperature of approximately 180° C. for 10 minutes, a film of very dark brown plastic was produced. The properties of this are different to those of the material produced in Example 6 and could be useful in different applications.

### Example 8

### Dried & Charred Calcium Phosphate Scum and Recycled High Density Polyethylene

A sample of the above dried phosphate scum was charred in the muffle furnace to give a black product. This product was ground using a mortar and pestle.

The composition of the dried material is given in Tables 11, 12 and 13. In Table 13, the lack of “sugars” relative to the data shown in Table 10 may be noted. The apparent removal of these sugars appears to be a result of the charring.

TABLE 11

| Cations | Content (ppm on solids basis) |
|---|---|
| Ca | 273000 |
| Cu | nd |
| Fe | 2550 |
| K | nd |
| Mg | 9720 |
| Mn | 196 |
| Na | nd |
| P | 108000 |
| S | 9370 |

TABLE 12

| Anions & Acids | Content (ppm on solids basis) |
|---|---|
| Chloride | 123 |
| Sulphate | 2109 |
| Phosphate | 35 |
| Oxalate | 147 |
| Citrate | 14 |
| Aconitate | 110 |
| Lactate | 4865 |
| Acetate | 405 |
| Malate | 509 |
| Formate | 970 |
| Nitrate | 41 |

TABLE 13

| Sugars, etc. | Content (% on solids basis) |
|---|---|
| Sucrose | nd |
| Glucose | nd |
| Fructose | nd |

350 g of granules of recycled HDPE (made from washed and processed plastic milk bottles) were compounded with 350 g of the charred/dried calcium phosphate scum.

The materials were compounded using a co-rotating intermeshing twin screw extruder and the extrudate was granulated and compression moulded using heated platens for 10 minutes. The compound was placed in a compression mould and heated to a temperature of approximately 180° C. for 10 minutes, a film of black plastic was produced. The properties of this are again different to those of the material produced in Example 5, 6 and 7, and could be useful in different applications.

1. An additive for inclusion as a filler in a plastic, resin or elastomer composition, the additive comprising a combination of precipitated calcium and/or magnesium salt and co-precipitated organic material, wherein the salt is a calcium and/or magnesium carbonate, a calcium and/or magnesium phosphate or a combination thereof and wherein the combination of precipitated salt and co-precipitated organic material is a by-product of a carbonatation and/or phosphatation decolourisation process and has a particle size of between 0.4 μm and 150 μm.

2. The additive of claim 1, wherein the additive comprises an intimate mixture of precipitated salt and organic material.

3. The additive of claim 1, wherein the additive comprises organic material and inorganic material bound to precipitated salt.

4. The additive of claim 1, wherein the combination of precipitated salt and organic material is a by-product of a refining process.

5. The additive of claim 1, wherein the combination of precipitated salt and organic material is a by-product of a sugar refining process.

6. The additive of claim 1, wherein the combination of precipitated salt and organic material is a by-product of decolourisation processes.

7. The additive of claim 1, wherein the additive has a particle size of up to about 50 μm, or up to about 10 μm, or up to about 1 μm.

8. The additive of claim 1, comprising at least 5% organic material.

9. The additive of claim 1, wherein the organic material comprises carbon, charred material or carbonised material.

10. A method of manufacturing the additive of claim 1, the method comprising processing a combination of calcium and/or magnesium salt and organic material.

11. The method of claim 10, wherein the processing comprises a heat treatment step.

12. The method of claim 11, wherein the heat treatment step results in the formation of carbon, charred material or carbonised material from the organic material.

13. The method of claim 11, wherein the combination of calcium and/or magnesium salt and organic material is heated to a temperature from about 200° C. to about 1000° C. for a period of about 30 minutes to about 5 hours.

14. The method of claim 10, wherein the method comprises adjusting the particle size of the combination of calcium and/or magnesium salt and organic material.

15. The method of claim 10, wherein the method comprises a washing step.

16. An additive material produced or producible by the method of claim 10.

17. The additive material of claim 16, wherein the additive material is an additive for inclusion in a plastic, resin or elastomer composition.

18. (canceled)

19. (canceled)

20. A process for preparing a plastic, resin or elastomer composition, wherein the process comprises mixing a plastic, resin or elastomer starting material with the additive of claim 1.

21. The process of claim 20, wherein the process does not comprise the addition of further colorant or pigment to the plastic, resin or elastomer composition.

22. A plastic, resin or elastomer composition comprising the additive of claim 1.

23. The plastic, resin or elastomer composition of claim 22, comprising a recycled plastic, resin or elastomer.

24. The plastic, resin or elastomer composition of claim 22, wherein the composition comprises between 1 and 99% additive based upon the total weight of the composition.

25. The plastic, resin or elastomer composition of claim 22, wherein the precipitated calcium and/or magnesium salt acts as a filler.

26. The plastic, resin or elastomer composition of claim 22, wherein the composition does not comprise additional colorant or pigment.

27. The method of claim 20, wherein the resulting plastic, resin, or elastomer composition comprises a homogeneous mixture of filler and colorant.
